(19) United States
(12) Patent Application Publication
(10) Pub. No.: US 2026/0183668 A1
(43) Pub. Date: Jul. 2, 2026

(54) METHOD FOR INTERACTION CONTROL IN GAME, ELECTRONIC DEVICE, AND STORAGE MEDIUM

(71) Applicant: NETEASE (HANGZHOU) NETWORK CO., LTD., Hangzhou, Zhejiang (CN)

(72) Inventor: Mingxin WU, Hangzhou, Zhejiang (CN)

(73) Assignee: NETEASE (HANGZHOU) NETWORK CO., LTD., Hangzhou, Zhejiang (CN)

(21) Appl. No.: 19/126,018

(22) PCT Filed: Apr. 4, 2023
(86) PCT No.: PCT/CN2023/086150

§ 371 Date: May 12, 2025

(30) Foreign Application Priority Data
Nov. 4, 2022 (CN) 202211374651.8

(51) Int. Cl. A63F 13/58; A63F 13/52; A63F 13/69

(52) U.S. Cl. CPC A63F 13/58; A63F 13/52; A63F 13/69

(57) ABSTRACT

A method for interactive controlling in a game includes: in response to an interactive behavior operation, controlling a controlled virtual object to execute an interactive behavior against a specified object; in response to an interaction condition being satisfied, updating an attribute parameter of the specified object, and increasing an experience parameter of the controlled virtual object according to a preset rule; in response to the experience parameter reaching a preset experience threshold, increasing an object level of the controlled virtual object in a game match, determining at least part of candidate items from a specified item set, and displaying the candidate items; in response to a selection operation on a first item from the candidate items, controlling the controlled virtual object to acquire the first item; and in response to a trigger operation on the first item, displaying a game behavior corresponding to the first item in the game scene.

### CROSS REFERENCE TO RELATED APPLICATION

The present application claims the priority of the Chinese Patent Application No. 202211374651.8, titled “method and apparatus for interaction control in game, and electronic device”, filed on Nov. 4, 2022, which is incorporated herein by reference in its entirety.

### TECHNICAL FIELD

The present disclose relates to the technical field of game, in particular to a method and an apparatus for interaction control in game, and an electronic device.

### BACKGROUND

In multi-player online tactical competitive games, after the player controls a character to enter a game match, the character progression can be implemented through operations such as attacking other characters, attacking non-player characters (NPCs), or collecting resources. Upon leveling up, various character attributes (e.g., a skill attribute, an equipment attribute, a health value, an attack power and the like) are enhanced, so that the character's competitive capability in the game match is improved. However, this character progression mode is monotonous, particularly for experienced players. Due to a lack of freshness of character progression operations, players are lost easily and game service resources are wasted.

### SUMMARY

Accordingly, the purposes of the present disclosure are to provide a method and an apparatus for interaction control in game, and an electronic device, so that the freshness and randomness of character progression operations are enhanced, a player loss rate is reduced, a utilization rate of game service resources is improved, and idle and waste of game service resources and server equipment resources are avoided.

In the first aspect, the embodiments of the present disclosure provide a method for interactive controlling in a game, where a graphical user interface is provided through a first terminal device; the graphical user interface includes a current game match interface; the current game match interface includes a game scene and a controlled virtual object located in the game scene; the controlled virtual object is controlled through the terminal device; the method includes: in response to an interactive behavior operation, controlling the controlled virtual object to execute an interactive behavior against a specified object; wherein the specified object includes at least one of following virtual objects: an object located in the game scene and controlled through a preset game program, and an object controlled through a second terminal device; in response to the interactive behavior and the specified object satisfying an interaction condition, updating an attribute parameter of the specified object according to the interactive behavior, and increasing an experience parameter of the controlled virtual object according to a preset rule; in response to the experience parameter reaching a preset experience threshold, increasing an object level of the controlled virtual object in a game match, determining at least part of candidate items from a specified item set, and displaying the candidate items; in response to a selection operation on a first item from the candidate items, controlling the controlled virtual object to acquire the first item; and in response to a trigger operation on the first item, controlling to execute a game behavior corresponding to the first item in the game scene.

In the second aspect, the embodiments of the present disclosure provide an interactive controlling apparatus in a game, providing a graphical user interface through a first terminal device; the graphical user interface includes a current game match interface; the current game match interface includes a game scene and a controlled virtual object located in the game scene; the controlled virtual object is controlled through the terminal device; the apparatus includes: a behavior control module configured to, in response to an interactive behavior operation, control the controlled virtual object to execute an interactive behavior against a specified object; wherein the specified object includes at least one of the following virtual objects: an object located in the game scene and controlled through a preset game program, and an object controlled through a second terminal device; a parameter control module configured to, in response to the interactive behavior and the specified object satisfying an interaction condition, update an attribute parameter of the specified object according to the interactive behavior, and increase an experience parameter of the controlled virtual object according to a preset rule; an item display module configured to, in response to the experience parameter reaching a preset experience threshold, increase an object level of the controlled virtual object in a game match, determine at least part of candidate items from a specified item set, and display the candidate items; an item acquisition module configured to, in response to a selection operation of a first item from the candidate items, control the controlled virtual object to acquire the first item; an item trigger module configured to, in response to a trigger operation of the first item, control to execute a game behavior corresponding to the first item in the game scene.

In the third aspect, the embodiments of the present disclosure provide an electronic device, including a processor and a memory storing a machine-executable instruction capable of being executed by the processor, where the processor executes the machine-executable instruction to implement the above method for interactive controlling in the game.

In the fourth aspect, the embodiments of the present disclosure provide a machine-readable storage medium storing a machine-executable instruction, where, when the machine-executable instruction is called and executed by a processor, the machine-executable instruction cause the processor to implement the above method for interactive controlling in the game.

The embodiments of the present disclosure have the following beneficial effects.

According to the method and apparatus for interaction control in game, and the electronic device as described above, the graphical user interface is provided through the first terminal device; the graphical user interface includes the current game match interface; the current game match interface includes the game scene and the controlled virtual object located in the game scene; the controlled virtual object is controlled through the terminal device; the method includes the followings. In response to the interactive behavior operation, the controlled virtual object is controlled to execute the interactive behavior against the specified object; where the specified object includes at least one of following virtual objects: the object located in the game scene and controlled through the preset game program, and the object controlled through the second terminal device. In response to the interactive behavior and the specified object satisfying the interaction condition, the attribute parameter of the specified object is updated according to the interactive behavior, and the experience parameter of the controlled virtual object is increased according to the preset rule. In response to the experience parameter reaching the preset experience threshold, the object level of the controlled virtual object in the game match is increased, at least part of candidate items are determined from the specified item set, and the candidate items are displayed. In response to the selection operation on the first item from the candidate items, the controlled virtual object is controlled to acquire the first item. In response to the trigger operation on the first item, the game behavior corresponding to the first item in the game scene is controlled to be executed. In the above implementations, during the progression of the game character in the game match, the experience parameters are increased through the fight with environmental objects and player objects. The item set is determined based on the object level, and the candidate items are selected from the item set. Players may then choose the item from the candidate items. Based on the implementations, the freshness and randomness of character progression operations are enhanced, the player loss rate is reduced, the utilization rate of game service resources is improved, and idle and waste of game service resources and server device resources are avoided.

Other features and advantages of the present disclosure will be set forth in the specification which follows, and in part will be obvious from the specification, or may be learned by practice of the present disclosure. The purposes and other advantages of the present disclosure are implemented and attained by the structure particularly pointed out in the specification, claims and appended drawings.

In order to make the above purposes, features and advantages of the present disclosure more obvious and easier to be understood, the following is a detailed description of preferred embodiments with reference to the attached drawings.

### BRIEF DESCRIPTION OF DRAWINGS

In order to explain the technical solution in the detailed description or the related technology of the present disclosure more clearly, the drawings needed in the description of the detailed description or the related technology will be briefly introduced below. Obviously, the drawings in the following description are only some implementations of the present disclosure. For the skilled in the art, other drawings can be obtained according to these drawings without inventive work.

FIG. 1 is a flowchart of a method for interactive controlling in a game provided by one of the embodiments of the present disclosure.

FIG. 2 is a schematic display diagram of an interaction prompt control provided by one of the embodiments of the present disclosure.

FIG. 3 is a schematic display diagram of an item acquisition control provided by one of the embodiments of the present disclosure.

FIG. 4 is a schematic diagram of an interactive controlling apparatus in a game provided by one of the embodiments of the present disclosure.

FIG. 5 is a schematic structural diagram of an electronic device provided by one of the embodiments of the present disclosure.

### DETAILED DESCRIPTION

In order to make the purpose, technical solution and advantages of the embodiments of the present disclosure clearer, the technical solution of the present disclosure will be described clearly and completely with the attached drawings. The described embodiments are a part of the embodiments of the present disclosure, but not the whole embodiments. Based on the embodiments of the present disclosure, all other embodiments obtained by those skilled in the art without creative work fall within the protection scope of the present disclosure.

At present, the character progression mode is monotonous, particularly for experienced players. Due to the lack of freshness of character progression operations, players are lost easily and game service resources are wasted. Accordingly, the embodiments of the present disclosure provide a method and an apparatus for interaction control in game, and an electronic device. The technology can be applied to all kinds of games, for example, related games that require the development and growth of game characters, or that require performing tactical competition through items.

The method for interactive controlling in the game according to one embodiment of the present disclosure can be run on a local terminal device or a server. When the method for interactive controlling in the game runs on the server, the method can be implemented and executed based on a cloud interactive system, where the cloud interactive system includes the server and a client device.

In an optional embodiment, various cloud applications, such as cloud games, can be run under the cloud interactive system. For example, cloud games refer to games based on a cloud computing. In the running mode of the cloud game, the running subject of the game program and the presenting subject of the game image are separated, the storage and running of the method for interactive controlling in the game are implemented on the cloud game server, and the client device is used for receiving and sending data and presenting the game image. For example, the client device can be a display device with data transmission function close to the user side, such as a mobile terminal, a television, a computer, a palmtop, and the like. However, the cloud game server in the cloud processes the information. The player, upon playing the game, operates the client device to send the operation instruction to the cloud game server, and the cloud game server runs the game according to the operation instruction, encodes and compresses data such as game images, and returns the data to the client device through the network, and finally decodes and outputs the game images through the client device.

In an optional embodiment, taking the game as an example, the local terminal device stores the game programs and is used to present the game images. The local terminal device is used to interact with the player through the graphical user interface, that is, to download and install the game program and run it through the electronic device. The local terminal device can provide the graphical user interface to the player in various ways. For example, it can be rendered and displayed on the display screen of the terminal, or it can be provided to the player through holographic projection. For example, the local terminal device may include the display screen and the processor. The display screen is used to present a graphical user interface including the game images, and the processor is used to run the game, generate the graphical user interface and control the display of the graphical user interface on the display screen.

In a possible implementation, the embodiments of the present disclosure provide the method for interactive controlling in the game, where the graphical user interface is provided through the terminal device, and the terminal device can be the above local terminal device or the above client device in the cloud interactive system.

Taking TPS (Third-Personal Shooting) tactical competitive game as an example, the game scene is preset at the beginning of the game match, and can be an island terrain, a mountain terrain, an urban terrain, and the like. A flying vehicle flies over the game scene along a preset path, and multiple virtual objects are in the virtual vehicle. During the flight of the flying vehicle, the players can control the controlled virtual objects to jump out of the flying vehicle at any time and land in the game scene by skydiving.

One game match is usually played by multiple players, so that multiple virtual objects are in the game scene corresponding to the game match. Each player controls a virtual object to participate in the game match. Virtual objects can participate in the game match alone or as a team, depending on the requirements of the game match. Virtual objects usually carry weapons items, such as guns, bullets, grenades, and the like, and can also carry therapeutic items, such as blood bags, and the like. Items may be scattered in the game scene and can be collected and used by the virtual objects. When a virtual object in the defeated state exists in the game scene, the items carried by the virtual object can also be collected and used by other virtual objects.

With the progress change of the game match, safe area and unsafe area will exist in the game scene. The health value or other skill abilities of the virtual objects in the unsafe area will continue to reduce. During the change of the match progress, the range of the safe area will be smaller and smaller, thus the surviving virtual objects are centrally guided to the safe areas.

For the controlled virtual object controlled by the terminal device, the controlled virtual object can attack other virtual objects through weapons items, thus the health value, the skill value or other object attributes of the attacked virtual object are reduced. When the attacked virtual object is defeated, the controlled virtual object can collect some items of the defeated virtual object and use them. If the controlled virtual object is in the unsafe area, the health value of the controlled virtual object will continue to reduce. The controlled virtual object is to reach the safe area as soon as possible, for example, it can quickly reach the safe area through a virtual vehicle.

When the controlled virtual object is located in the unsafe area for a long duration, or attacked by other virtual objects, the health value of the controlled virtual object is reduced. When the health value is reduced to zero, the controlled virtual object is defeated. If other virtual objects in the game scene are defeated and the controlled virtual object survives, the controlled virtual object or the team of the controlled virtual object wins the match. If the controlled virtual object is defeated but the teammates of the team of the controlled virtual object win the match, the team of the controlled virtual object wins the match. If the controlled virtual object has no teammates and the controlled virtual object is defeated, the match of the controlled virtual object fails. If the controlled virtual object has teammates, and both the controlled virtual object and teammates are defeated, the match of the controlled virtual object fails.

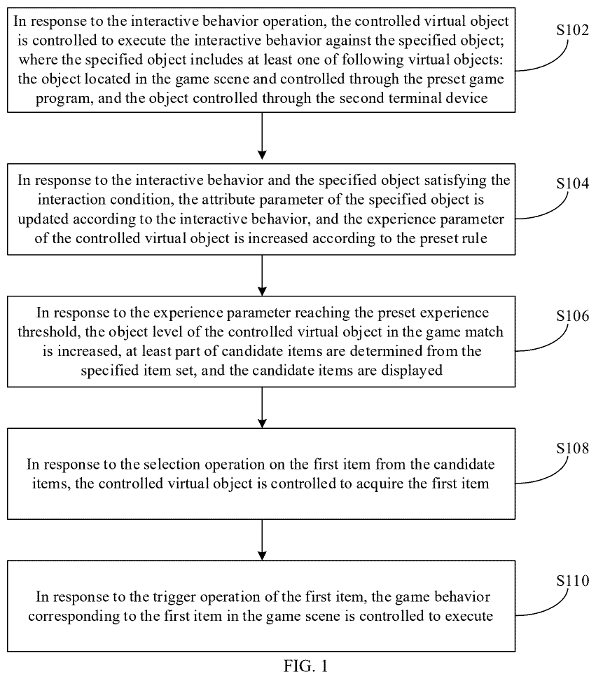

Based on the above game scene, firstly, the method for interactive controlling in the game disclosed in the embodiments of the present disclosure is introduced in detail. As shown in FIG. 1, with respect to the method for interactive controlling in the game, the graphical user interface is provided through the terminal device, where the terminal device is the above local terminal device or the above client device. The graphical user interface includes the current game match interface; the current game match interface includes the game scene and the controlled virtual object located in the game scene; and the controlled virtual object is controlled through the terminal device. At the beginning of the game match, the controlled virtual object lands in the game scene from the flying vehicle, and moves, collects items and performs shooting operations in the game scene. The virtual camera moves along with the controlled virtual object. In the third-person games, the virtual camera follows behind the controlled virtual object, and the captured scene image includes the controlled virtual object. In the first-person games, the virtual camera captures a scene image of the visual field of the controlled virtual object, and the scene image may include parts of the body of the controlled virtual object.

Interactive controls, such as a move control and various skill controls, are also displayed in the graphical user interface. The player triggers these interactive controls through the terminal device, so as to control the position, posture and action of the controlled virtual object in the game scene through the terminal device.

The method includes the following steps.

In step S102, in response to the interactive behavior operation, the controlled virtual object is controlled to execute the interactive behavior against the specified object; where the specified object includes at least one of following virtual objects: the object located in the game scene and controlled through the preset game program, and the object controlled through the second terminal device.

The interactive behavior operations include movement control operation, attack operation, item release operation, article collecting operation, and the like. After the player performs those interactive behavior operations, the player can control the controlled virtual object to perform actions such as moving, attacking, throwing items, shooting, collecting article, and the like. The above specified objects can be virtual objects controlled by game programs, such as NPC (Non-Player Character), World Boss, and the like. The specified objects can also be the virtual objects controlled by other players through the second terminal device. The second terminal device is a terminal device corresponding to other players.

In an optional implementation, the game scene not only includes the virtual objects controlled by the terminal devices that participate in the game match, for example, the controlled virtual object controlled by the first terminal device, virtual objects controlled by other terminal devices that belong to the same camp as the controlled virtual object, and the virtual objects that belong to different camps from the controlled virtual object. It should be noted that in the present implementation, the game scene also includes non-player character virtual objects NPC. The virtual objects participating in the game match can obtain game resources by interacting with NPC to play the game match.

In step S104, in response to the interactive behavior and the specified object satisfying the interaction condition, the attribute parameter of the specified object is updated according to the interactive behavior, and the experience parameter of the controlled virtual object is increased according to the preset rule.

The interaction condition can be understood as: the interactive behavior acts on the specified object, or the interaction behavior has an impact on the specified object. For example, when the interactive behavior is an attack behavior, if the attack behavior acts on the specified object, the health value of the specified object will be reduced. For another example, when the interactive behavior is an item release behavior, if the specified object is within the item release range, the health value of the specified object will also be reduced.

The game scene includes multiple virtual objects; the controlled virtual object belongs to the multiple virtual objects. The object state of the controlled virtual object is impacted by the specified action of the first virtual object among the multiple virtual objects, or by the scene state of the scene position where the controlled virtual object is located. The first virtual object is the controlled virtual object or a virtual object other than the controlled virtual object.

The above preset rule can include: the interactive behaviors that can increase experience parameters and the corresponding increase amount of experience parameters for each interactive behavior. In addition, the increase amount of experience parameters can also be determined according to the result of interactive behaviors. For example, for the attack behavior, the increase amount of experience parameters is determined according to the decrement of the health value of the attacked object or the number of objects attacked and defeated. Accordingly, when the controlled virtual object performs interactive behavior in the game scene, the experience parameters of the controlled virtual object can be determined according to the interactive behavior or the results of the interactive behaviors.

In practical implementation, when the controlled virtual object just enters the game scene, that is, at the beginning of the game match, one initial value of the experience parameter can be preset. Then, in the process of the game match, the experience parameter is gradually increased based on the initial value.

The move control, such as move joystick, is displayed in the graphical user interface. The player controls the controlled virtual object to move in the game scene by triggering the move control. In a game match, the multiple virtual objects participate together. If the controlled virtual object participates in the game match alone, all the virtual objects except the controlled virtual object are enemy objects. If the controlled virtual object joins a team to participate in the game match, the virtual objects other than teammates are enemy objects.

The object states of the controlled virtual object can include numerical states such as health value, magic value, and the like. The object state of the controlled virtual object may be impacted by any virtual object in the game scene or the scene state of the scene position in the game scene. For example, when the first virtual object is a virtual object other than the controlled virtual object, the first virtual object may perform an attack action on the controlled virtual object, such as shooting with the gun, releasing attack items, and the like. If the controlled virtual object is hit, the health value of the controlled virtual object will be reduced. When the first virtual object is a teammate object, the first virtual object may perform rescue actions on the controlled virtual object, for example, using blood supply items, and the like, to the controlled virtual object. Accordingly, the health value of the controlled virtual object will increase. For another example, the first virtual object may be the controlled virtual object itself. For example, the controlled virtual object uses blood supply items for itself. Accordingly, the health value of the controlled virtual object will also increase.

In addition, the object state of the controlled virtual object will also be impacted by the scene state of the scene position where the controlled virtual object is located. For example, the scene state can include a safe state and an unsafe state. Based on the scene state, the game scene is divided into a safe area and an unsafe area. If the controlled virtual object is located in the unsafe area, the health value of the controlled virtual object may be reduced, and the skill or item effect of the controlled virtual object may also be impacted, thus the object state of the controlled virtual object will be impacted.

In step S106, in response to the experience parameter reaching the preset experience threshold, the object level of the controlled virtual object in the game match is increased, at least part of candidate items are determined from the specified item set, and the candidate items are displayed.

When the controlled virtual object just enters the game scene, that is, at the beginning of the game match, the initial value of the object level can be preset, for example, zeroth level or first level. The multiple object levels, and the experience thresholds corresponding to each object level, can be preset. When the experience parameters increase continuously and reach the experience threshold corresponding to the next level, the object level is increased from the current level to the next level.

The purpose of these embodiment is to provide various game items in the game match, so as to meet the needs of players in the game match, and promote the development of game characters in the game match. Accordingly, when the object level of the controlled virtual object increases one level, the item acquisition control is displayed in the graphical user interface. The item acquisition control can be displayed in the specified position in the graphical user interface, and the prompt information can also be displayed, and the prompt information is used to prompt the player to acquire the items by triggering the item acquisition control.

For example, a game system can be preset with multiple sets of candidate items, and the types, quantities and functions of items in different candidate item sets may be different. According to the object level of the controlled virtual object, the specified item set is determined from the candidate item sets. The specified item sets corresponding to different object levels can be different or partially different, so that the controlled virtual object can obtain items with different types or different attributes in different object levels.

In practical implementation, one or more candidate items can be determined from the specified item set according to preset rules, such as random distribution, random drawing, or allocation to each virtual object in a certain order, and the like. After the candidate item(s) is determined, the candidate item(s) can be displayed in the graphical user interface, and the information such as the purpose of the candidate item(s) can also be displayed.

In addition, when the experience parameters of the controlled virtual object reach the preset experience threshold, at least part of candidate items can be automatically determined from the specified items set, and the game system can also display the above item acquisition control on the first terminal device. Then the player corresponding to the controlled virtual object can determine the candidate items through the item acquisition control. Candidate items corresponding to different virtual objects can be the same or different. For some special items, they can be obtained and used by only one virtual object in one game match.

In step S108, in response to the selection operation on the first item from the candidate items, the controlled virtual object is controlled to acquire the first item.

The above candidate items can include one or more. After these candidate items are displayed in the graphical user interface, the player can select one or more of them. The selected item is the first item. After the first item is selected, it can enter the backpack of the controlled virtual object, and the controlled virtual object can use the first item.

In step S110, in response to the trigger operation of the first item, the game behavior corresponding to the first item in the game scene is controlled to be executed.

The first item can be used to update the object state of an item-acting object of the first item and/or update the specified scene state of the game scene. The item-acting object includes the controlled virtual object or the virtual objects other than controlled virtual object. The above game behavior is associated with the item function of the first item.

In these embodiment, the first item can have various item functions. The controlled virtual object can use the first item to other virtual objects or itself, and can also use the first item to the game scene. Therefore, the item-acting object of the first item can be other virtual objects, the controlled virtual object itself or the game scene. The item-acting object can be determined according to the function of the first item and the virtual objects nearby when the first item is used.

For example, when the first item is the attack item, such as guns, grenades, and the like. The virtual object(s) within the skill release range of the first item is the item-acting object, and the health value of the item-acting object may be reduced. When the first item is an item that changes the scene state, the item-acting object is the game scene or a local scene area in the game scene. After the first item is released, the terrain, weather and other states of the game scene or the target scene area change.

For the above method for interactive controlling in the game, the graphical user interface is provided through the first terminal device; the graphical user interface includes the current game match interface; the current game match interface includes the game scene and the controlled virtual object located in the game scene; the controlled virtual object is controlled through the terminal device; and the method includes the followings. In response to the interactive behavior operation, the controlled virtual object is controlled to execute the interactive behavior against the specified object, where the specified object includes at least one of following virtual objects: the object located in the game scene and controlled through the preset game program, and the object controlled through the second terminal device. In response to the interactive behavior and the specified object satisfying the interaction condition, the attribute parameter of the specified object is updated according to the interactive behavior, and the experience parameter of the controlled virtual object is increased according to the preset rule. In response to the experience parameter reaching the preset experience threshold, the object level of the controlled virtual object in the game match is increased, at least part of candidate items are determined from the specified item set, and the candidate items are displayed. In response to the selection operation on the first item from the candidate items, the controlled virtual object is controlled to acquire the first item. In response to the trigger operation on the first item, the game behavior corresponding to the first item in the game scene are controlled to be executed. In the above modes, during the progression of the game character in the game match, the experience parameters are increased through the fight with environmental objects and player objects. The item set is determined based on the object level, and the candidate items are selected from the item set. Players may then choose items from the candidate items. The implementation enhances the freshness and randomness of character progression operations, reduces the player loss rate, and improves the utilization rate of game service resources.

The following provides a specific implementation for increasing the experience parameters.

In response to the attack operation against the specified object, the controlled virtual object is controlled to execute the attack action against the specified object, or the controlled virtual object is controlled to release the attack item to the specified object.

The player can issue the attack operation through the attack control. The attack operation can include an item release operation or a close-range attack operation, and the like. Therefore, the attack action can include the shooting action of firearms, the use and operation of dagger items, and the like. The above attack items can include grenades, shock bombs and other items. The above specified objects can be virtual objects controlled by game programs, such as NPC, World Boss, and the like. The specified objects can also be the virtual objects controlled by other players through the second terminal device. The second terminal device is a terminal device corresponding to other players.

In response to the interactive behavior successfully acting on the specified object, the health parameter of the specified object is controlled to reduce based on the impact degree of the interactive behavior on the specified object, and the experience parameter of the controlled virtual object is controlled to increase.

After the attack operation is successfully performed on the specified object, the health parameter of the specified object will gradually reduce. Specifically, the health parameter can be health value, blood volume, and the like. Since the controlled virtual object attacks the specified object and causes damage, the experience parameters of the controlled virtual object will increase. The increase amount of experience parameters can be related to the damage amount caused by the controlled virtual object to the specified object, or to the number of specified objects attacked and defeated by the controlled virtual object.

In another implementation, in response to the controlled virtual object entering the game scene, the experience parameter of the controlled virtual object is increased based on the scene duration of the controlled virtual object in the game scene. In this case, the longer the duration of the controlled virtual object in the game scene, the more the experience parameter it has. In practical implementation, the increase of experience parameters can be related to various parameters such as the scene duration, the attack action against the specified object, and the release of attack items to the specified object.

In the above implementation, the character progression can be implemented through means of the fight with environmental objects, the fight with player objects, game duration, and the like by the game character, so as to increase the experience value and upgrade the object level, thereby enriching the content of character progression and growth, improving the richness of character progression operations, and helping improve the player's retention.

Further, the attribute parameter of the controlled virtual object is set based on the object level, where the attribute parameter includes one or more parameter(s) of: the attack power parameter, the defense power parameter, the health parameter, and the movement speed. The higher the object level, the greater the parameter value of the attribute parameter. Multiple object levels and corresponding attribute parameters of each object level can be preset in the game system. When the controlled virtual object reaches a new object level, the attribute parameters of the controlled virtual object are set according to the new object level.

For example, six object levels can be set, ranging from zeroth level to fifth level. Attribute parameters of zeroth level are initial values, those of first level are 125% of the initial values, those of second level are 150% of the initial values, those of third level are 175% of the initial values, those of fourth level are 200% of the initial values and those of fifth level are 225% of the initial values.

In one Implementation, the object level may also be related to the target scene area of the game scene. In some games, the target scene area is also called the “poison zone”, and multiple target scene areas are preset, with the ranges of different target scene areas being different. When the game scene is the first target scene area, the object level of the controlled virtual object can be controlled as zeroth level. When the game scene is the second target scene area, the object level of the controlled virtual object can be controlled as second level. When the game scene is the third target scene area, the object level of the controlled virtual object can be controlled as second level or third level. When the game scene is the fourth target scene area, the object level of the controlled virtual object can be controlled as third level or fourth level. When the game scene is the fifth target scene area, the object level of the controlled virtual object can be controlled as fifth level.

In another embodiment, tasks to be completed by the controlled virtual object at different object levels can also be preset. For example, at the zeroth level, the controlled virtual object reaches the game scene through skydiving operation, and acquires basic materials in the game scene; at the first level, the controlled virtual object and the virtual object in the game scene have an attack behavior, the character progression is implemented, and the related items are acquired when the object level is upgraded; at the second level, by attacking environmental characters, such as NPC, World Boss, and the like, or attacking the virtual characters controlled by other players, the experience parameters are improved, and the related items are acquired when the object level is upgraded; at the third level, the controlled virtual object moves to the safe area, and performs a higher-intensity character attack operation, and the related items are acquired when the object level is upgraded; at the fourth level, virtual objects push to take zone, may engage in combat encounters, and the like; at the fifth level, the controlled virtual object can use scene items to change the environmental state of the game scene, and then win the match.

It should be noted that no mandatory binding between the object level and the target scene area exists. Similarly, no mandatory binding between the object level and the tasks that the controlled virtual object is to complete exists. But players can be guided or prompted to complete tasks or perform behaviors at different object levels.

In practical implementation, when the experience parameters reach the preset experience threshold, the candidate items can be automatically acquired from the specified items set, or the candidate items can be acquired from the specified items set by the way of player triggering. Specifically, in response to the experience parameter reaching the preset experience threshold, the item acquisition control is displayed in the graphical user interface; and in response to the first trigger operation on item acquisition control, the at least part of candidate items are determined from the specified item set and the candidate items are displayed.

When the experience parameters of the controlled virtual object reach the preset experience threshold, the game system can display the above item acquisition control on the first terminal device, and then the player corresponding to the controlled virtual object can determine the candidate items through the item acquisition control. Candidate items corresponding to different virtual objects can be the same or different. For some special items, they can be obtained and used by only one virtual object in one game match.

When the item acquisition control is displayed, in a specific implementation, in response to the experience parameter reaching the preset experience threshold, the interaction prompt control is displayed in the graphical user interface; where the interaction prompt control is configured to prompt to execute the interaction operation of acquiring the item; and in response to the trigger operation on the interaction prompt control, the item acquisition control is displayed in the graphical user interface.

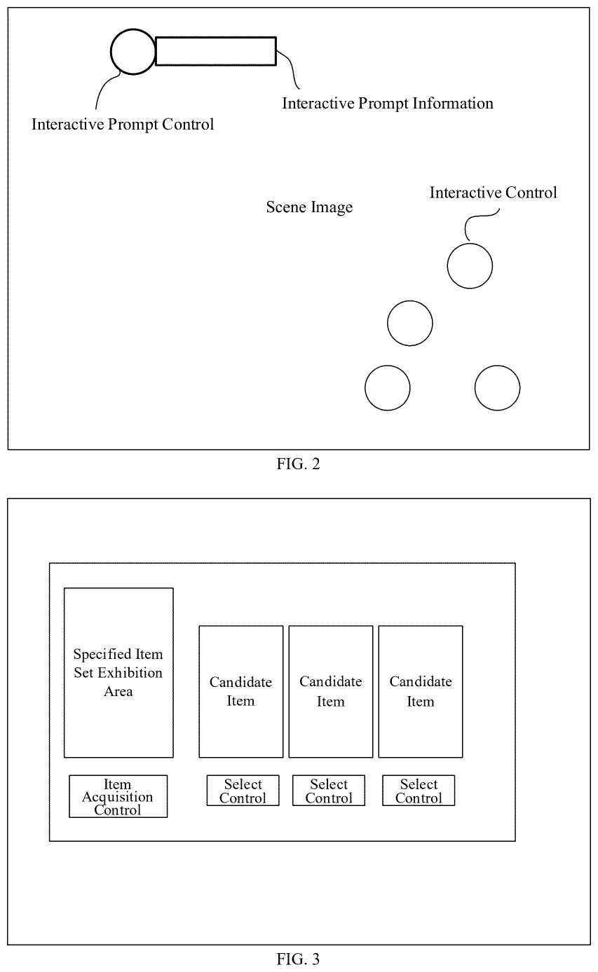

As shown in FIG. 2, during the game match process, the scene image of the game scene is displayed in the graphical user interface, and various interactive controls are displayed on the scene image. After the experience parameter reaches the preset experience threshold, the interaction prompt control is displayed on the graphical user interface, and the interaction prompt control can be displayed in highlighted, blinking and other formats to attract players to see. The interactive prompt information can also be displayed around the interaction prompt control, the interactive prompt information is used for prompting that the items can be get by triggering interaction prompt controls.

As shown in FIG. 3, when the interaction prompt control in FIG. 2 is triggered, a window can be generated in the graphical user interface, and the item acquisition control can be displayed in this window. Before the item acquisition control is triggered, only the set information of the specified item set can be displayed in the window, such as the types and attributes of the items in the set. After the item acquisition control is triggered, the candidate items determined from the specified item set can be displayed in the window. In the example of FIG. 3, three candidate items are determined, each of which corresponds to a selection control, and the player selects the first item by triggering the selection control.

It should be noted that the first item is configured to, in response to the trigger operation, perform at least one of the following game behaviors: the gain effect for the controlled virtual object in the game scene is controlled to generate; and/or the specified scene object in the game scene is controlled to update, causing the controlled virtual object and the virtual object other than the controlled virtual object to execute the current game match in the updated specified scene object.

For example, the acting object of the first item is the controlled virtual object itself or the teammate object. For a blood-enriching item, the health value of the controlled virtual object or the health value of the teammate object can be increased, it is conducive to increase the game performance of the controlled virtual object or the team. The acting object of the first item can also be virtual objects other than the controlled virtual object. For the attack items, after causing damage to other virtual objects, the experience value, object level and object attack capability of the controlled virtual object can be increased, and the winning probability of the controlled virtual object can be improved, thereby being conducive to improving the game performance of the controlled virtual object in the game match.

The first item can also update the specified scene object in the game scene, the game scene is a virtual world composed of preset virtual objects with different forms, functions or meanings, and the game match is the process in which the virtual objects located in the game scene and controlled by the players perform the target tasks. For example, the game scene is composed of virtual terrain, buildings, weather and preset change rules in the scene. In the present implementation, the specified scene objects are the virtual objects that constitute the game scene, such as scene weather, scene terrain, the range of the target scene area, and the like. After the specified scene object is updated, all or part of the virtual objects in the game scene are impacted. For example, after the weather of the scene is changed, all the virtual objects in the game scene are impacted by the weather, for example, the moving speed is reduced and the health value is continuously reduced. In the present implementation, the first item usually does not directly generate the gain effect on the controlled virtual object. After the first item is released, all virtual objects in the game scene will suffer the same impact, or some virtual objects will be impacted according to their positions. For example, the first item can change the local terrain of the scene, and the virtual objects located in the local terrain will suffer a corresponding impact on the terrain. By updating the scene object in the scene through the first item, the game process can be accelerated and the pressure on the server can be reduced.

The following embodiments describe the determination of the specified item set.

At least one specified item set is determined from multiple candidate item sets based on the object level of the controlled virtual object, where different candidate item sets contain items with different item attributes. There may be many items in the game system, and the items can be divided into several candidate item sets according to their functions, triggering modes, acting objects and other attributes. Items in different candidate item sets can be different or partially different. The items can also be divided from different dimensions to obtain multiple candidate item sets according to different item attributes.

Then, after setting the object level corresponding to each candidate item set, one or more candidate item sets are determined as specified item set according to the current object level after the object level is increased.

In practical implementation, the candidate item sets include the active item set, the passive item set, and the scene item set. The active item set includes the active item, and the active item is configured to, after the release operation is performed on the active item, release the item function to the item release target object of the active item. The passive item set includes the passive item, and the passive item is configured to, after being acquired by the controlled virtual object, release the item function to the item release target object of the passive item. The scene item set includes the scene item, and the scene item is configured to, after the release operation is performed on the scene item, release the item function to the item release target scene position of the scene item, thereby impacting both the controlled virtual object and the virtual object. It can be understood that after the scene items are released, all the virtual objects in the game scene will be impacted by the scene items.

The above active items can be understood as, after the items are actively released by the controlled virtual object, the items will generate the gain effect on the controlled virtual object. The active items can be used for many times, and the skill cooling time can be preset. When the controlled virtual object is defeated, the active items may not fall off or be collected by other virtual objects. The active items can include the items shown in Table 1 below, and Table 1 also shows the corresponding functions of the items.

TABLE 1

| Item Name | Item Function |
|---|---|
| Time-Freeze Item | Upon being used, with the controlled virtual object as the center, the |
| | time flow velocity within the radius of 100 meter will be changed |
| | within 10 seconds, the behavior of other objects except the user will |
| | become slow. |
| Petrification Item | Upon being used, the controlled virtual object will be immediately |
| | static, in an invincible state for 3 seconds, immune to all damage from |
| | enemy objects. Active operations such as moving and attacking will |
| | interrupt the petrochemical state. |
| Dash Item | Upon being used, the controlled virtual object will burst into |
| | extremely high moving capability within 5 seconds, and the moving |
| | speed and jumping height will be greatly improved. |
| Turret Item | Upon being used, the controlled virtual object will build a turret in |
| | situ, and the turret will automatically attack the targets visible within |
| | 200 m. |
| Life Field Item | Upon being used, the controlled virtual object will deploy a life field |
| | in situ, and the allied objects in the range will continue to recover |
| | their health value. |
| Super Jump Item | Upon being used, the controlled virtual object will make a super jump |
| | in the target direction, and upon landing, causes damage to enemies |
| | within the range of 10 meter. |

The above passive items can be understood as, after the controlled virtual object obtains the items, the items always exist, and can continuously generate the gain effect for the player without being actively triggered by the controlled virtual object. The passive items and the active items can jointly construct the player's comprehensive skill framework, and the passive items may not fall and may not be collected by other virtual objects. The passive items can include the items shown in Table 2 below, and Table 2 also shows the corresponding functions of the items.

TABLE 2

| Item Name | Item Function |
|---|---|
| Tracker Item | After the enemy object is hit, the position of the enemy object can be |
| | tracked. |
| Decoy Item | After the controlled virtual object is hit, the illusion effect will be |
| | triggered, and three illusion objects will split from the controlled |
| | virtual object to escape in different directions. |
| Scanner Item | With the controlled virtual object as the center, 100-meter radius |
| | around the controlled virtual object is automatically scanned every |
| | minute, and if the enemy object exists, it will be highlighted. |
| Titan Item | After the controlled virtual object is attacked and falls to the ground, |
| | the pistol items can be used to fight back. |
| Cloak Item | After the controlled virtual object is static, it will be kept in a stealth |
| | state and is not easy to be found by other objects. |
| Speed Boost Item | After the controlled virtual object is attacked, the moving speed will |
| | increase. |
| Cannon Tower Item | After the enemy object is hit, the ability of the enemy object to restore |
| | health value will be reduced. |
| Marksman Item | Weapons with strong attack can be extracted from the arsenal. |

In addition to the active and passive items provided above, scene items are also provided. Scene items can also be called strategic items. After being used, the scene items change the global weather of the game scene, or the original state of the terrain or the target scene area, and change the initial state of the specified object in the game scene. In a game match, each scene item can be acquired only once, and will disappear after being used. If the virtual object with the scene item is defeated, the scene item can fall into the game scene, and can be collected and used by the surviving virtual object. Generally, in some embodiments, one virtual object can carry at most one scene item.

For example, the target scene area usually appears in the game scene. In some games, the range of the target scene area is also called the poison zone. The above scene items can include poison zone items, for changing the change speed and scope of poison zone. The above scene items can also include weather items, for changing the weather in the game scene into fog, night, snowstorm, sandstorm, thunderstorm, and the like. The above scene items can also include terrain items, for generating the swamp terrain, the low-gravity terrain, the skill-disable terrain, and the like in the specific scene area.

According to the above various candidate item sets, when the specified item set is determined, in a specific implementation, when the object level of the controlled virtual object is the first level, the specified item set includes the active item set; when the object level of the controlled virtual object is the second level, the specified item set includes the passive item set; where in the current game match, the second level is higher than the first level, and the object level of the controlled virtual object increases from the first level to the second level. When the object level of the controlled virtual object is the third level, the specified item set includes the scene item set; where in the current game match, the third level is higher than the second level, and the object level of the controlled virtual object increases from the second level to the third level.

In the above implementation, when the object level is low, such as the first level, the player can choose the active item. Further, based on the active item, when the object level is medium, such as the second level, the player can choose to match the passive item. When the object level is high, such as the third level, the player can choose the scene item, so that players can use different items in the process of match, and improve their competitive performance through the collocation of different items.

As an example, the object level can be divided into six levels. At the zero level, no control for acquiring items is provided; at the first level, the specified item set is the active item set; at the second level and the third level, the specified item set is the passive item set; at the fourth level, the specified item set is the collocation of the passive item set and the scene item set; at the fifth level, the specified item set is the scene item set.

After the specified item set is determined, in order to improve the player's interest in acquiring items and make the player's decision-making more diversified, the candidate item can be determined in a random way. Specifically, in response to the first trigger operation on the item acquisition control, the at least part of candidate items are determined from the specified item set and the candidate items are displayed. As shown in FIG. 3, after the player clicks on the item acquisition control, the game system randomly determines three candidate items from the specified item set. Each candidate item is displayed in the interface, and the information such as item usage, item effect, and the like of each candidate item can also be displayed. Players can choose an item from the multiple candidate items. Players can put it in their backpacks or use it.

When the above specified trigger event occurs, the player can be provided with an opportunity to acquire items for free, that is, player can acquire items without consuming the resource quantity of the controlled virtual object. Specifically, at least part of candidate items are determined from the specified item set, the candidate items are displayed, and the resource quantity of the specified resource of the controlled virtual object is maintained unchanged. For example, the item acquisition control is displayed in the graphical user interface. The player can draw part of candidate items from the specified item set by clicking the item acquisition control once. The draw process does not consume the resource quantity of the specified resource, so that the resource quantity of the specified resource of the controlled virtual object is maintained unchanged.

Further, if none of the above candidate items is what the player wants, the game system can also provide an opportunity to re-determine the candidate items. Specifically, in response to the second trigger operation, the resource quantity of the specified resource of the controlled virtual object is updated; and at least part of candidate items are re-determined from the specified item set, and display of determined candidate items is updated.

For example, the above second trigger operation can be a re-click operation acting on the item acquisition control, and the quantity of resource consumed can be related to the operation times of the second trigger operation. For example, the more times of the second trigger operation, the more quantity of resource consumed by a single second trigger operation. The above specified resource of the controlled virtual object is: the virtual currency owned by the game account corresponding to the controlled virtual object outside the current game match, where the virtual currency is used for acquiring the virtual article provided by the game outside the current game match. In the implementation, global resources, that is, resources in the game account of the controlled virtual object, such as gold coins, virtual currency, and the like in the game account, are to be consumed when the items are re-acquired.

In a specific implementation, when the player is to get multiple opportunities to determine candidate items, the resources, such as gold coins, diamonds, coupons or cash, are to be consumed. Each time candidate items are re-determined, the quantity of consumed resource may be the same or different. In one example, the opportunity to re-determine candidate items can be preset to five times, and the quantity of consumed resource will increase gradually. For example, when re-determining candidate items for the first time, five gold coins will be consumed; and when re-determining candidate items for the second time, ten gold coins will be consumed. When the player has determined the candidate items once, a prompt information can be displayed on or around the item acquisition control, so as to remind the quantity of resources to be consumed when the player clicks the item acquisition control again to determine the candidate items. Each time the candidate items are determined, part of the candidate items are randomly drawn from the specified items set and displayed on the interface.

In the implementation, the player can get the opportunity to draw items for many times by consuming resources. Therefore, the chances of players getting the desired items are improved, so that the player's decision-making is more diversified and the players' participation and interest in the game are improved.

Some special items can be set in the game, and the number of times these items can be used in a game match is limited. Accordingly, it is to limit the number of times these items are determined as candidate items in the process of determining candidate items. In a specific implementation, when the first item belongs to the scene item set, the first item will be deleted from the scene item set to obtain the updated scene item set; where the updated scene item set is used for providing the scene item to the virtual object other than the controlled virtual object in the current game match.

In the implementation, it is preset that each kind of scene items only are obtained once in a game match. Accordingly, if the determined candidate item includes scene item, and the player selects the scene item, that is, if the above first item is scene item, when other players determine the candidate item from the scene items set, the first item will be deleted from the scene items set in advance to prevent other players from selecting the same scene items.

In practical implementation, after the specified trigger event occurs, the above item acquisition control can be displayed on the terminal device corresponding to each virtual object that survives in the game match, but the time sequence is present among players' operations of the item acquisition control. Therefore, the player who first operates the item acquisition control can randomly determine the candidate items from all the scene items in the scene item set, and the player who subsequently operates the item acquisition control is to randomly determine the candidate items from the scene item set from which the acquired items have been deleted.

According to the above embodiments, scene items can impact the specified scene state of the game scene. The following embodiments describe the specific impacts of different items of the first items on the game scene when the first items acquired by the controlled virtual objects are scene items.

In practical implementation, the first item is used to update the specified scene state of the game scene; in response to the release operation on the first item, the specified scene state of the game scene is updated, and the object states of at least part of the virtual objects are updated based on the updated specified scene state. It should be noted that after the first item is released, the specified scene state of the game scene is updated, and the specified scene state may impact the object state of all or part of the virtual objects in the game scene, such as the scene visibility, the health value, the skill release capability, and the like. The specified scene state can continue to impact until the end of the game match, or it can only impact for a certain period of time.

In the implementation, items can impact the scene state and the object state of virtual objects through the scene state, so as to increase the richness of items, increase various game experiences for players, promote the game process and improve the competitiveness of the game.

In the implementation of a scene item, the scene item can change the range or change speed of the target scene area. Specifically, the target scene area is preset in the game scene, and the range of the target scene area changes according to the default area adjustment rule and based on the match progress of the current game match. For example, the range can be gradually increased or gradually reduced. The object attribute of the virtual object in the scene area outside the target scene area changes according to the default attribute adjustment rule, for example, the health value gradually reduces or increases, the skill attributes gradually reduce or increase, and the like.

In response to the release operation on the first item, the range of the target scene area is controlled to modify and/or the range change time of the target scene area is controlled to modify according to the rule adjustment parameter corresponding to the first item, where the rule adjustment parameter is different from the default area adjustment rule. The first item can increase or reduce the range of the target scene area, and can also change the position of the target scene area in the game scene. The first item can also advance or postpone the change time of the range, or suspend the change of the range. After the first item is released, the way of adjusting the target scene area according to the default area adjustment rule is changed, so that the target scene area is adjusted according to the rule adjustment parameters corresponding to the first item, and the change rule of the target scene area is changed.

In the implementation, by changing the range of the target scene area, the object state of the virtual object in the game match can be impacted, thus changing the match state of the game match to a certain extent and impacting the final match result. The item can improve the uncertainty of the game match and improve the interest and freshness of players participating in the game match.

As an example, the range of the target scene area gradually reduces according to the match progress of the current game match; and the health value of the virtual object in the scene area outside the target scene area gradually reduces. In some games, the range of the target scene area is also called the poison zone, and the blood volume of the virtual object outside the range is reduced until the virtual object is defeated. The blood volume of virtual objects located within the range is not impacted by the environment.

In response to the release operation on the first item, the range of the target scene area is updated based on the position of the controlled virtual object in the game scene. For example, the position of the controlled virtual object in the game scene is taken as the center position of the target scene area, and the position area of the range in the game scene is updated, with the center position of the updated scene position being the position of the controlled virtual object. In addition, after the first item is released, the range can be updated immediately according to the position of the controlled virtual object, or it can be updated according to the position of the controlled virtual object at the next time point of updating the range. In order to ensure the rationality of updating the range, it can be limited that the first item can be released only when the controlled virtual object is within the target scene area.

After the range of the target scene area changes, some virtual objects may be switched from inside to outside the target scene area, or some virtual objects may be switched from outside to inside the target scene area.

The implementation changes the environment of the game scene, so that the controlled virtual object is in the most favorable environment area and the competitive performance of the controlled virtual object can be improved.

In another example, the range of the target scene area gradually reduces according to the match progress of the current game match; the health value of the virtual object in the scene area outside the target scene area gradually reduces. In response to the release operation on the first item, when the release time of the first item belongs to a range static stage of the target scene area, the range change time of the target scene area will be advanced or postponed. When the release time of the first item belongs to the change stage of the range of the target scene area, the change speed of the range of the target scene area will be increased or decreased.

In the game match, in some time stages, the range of the target scene area remains unchanged. Accordingly, it is called the range static stage. However, in some time stages, the range of the target scene area gradually reduces. Accordingly, it is called the range change stage. When the first item is used as an acceleration item, it can be used at any stage of the game match. If the first item is released at the range static stage of the target scene area, the reduction of the range of the target scene area can start in advance; and if the first item is released at the range change stage of the target scene area, the range can be reduced rapidly.

When the first item is used as a suspending item, it can be used at any stage of the game match. If the first item is released at the range static stage of the target scene area, the reduction of the range of the target scene area can be postponed; and if the first item is released at the range change stage of the target scene area, the reduction process of the range can be suspended for a preset time period, such as 1 minute.

In the above implementation, the scene items can change the changing rule of the target scene area in the game scene, and have a significant impact on the match state of the game match, thereby making the match state more favorable to the controlled virtual object and improving the competitive performance of the controlled virtual object.

In the implementations of another scene item, the scene items can change the weather in all or part of area of the game scene. Specifically, in response to the release operation on the first item, the scene weather of the game scene is controlled to change to the target weather. The target weather is configured to generate the impact corresponding to the target weather on the object state of the virtual object in the game scene. In practical implementation, the first item can change all the weather in the game scene, or only change the weather in part of scene area. The weather can impact the object states of the virtual objects located in the weather, such as the health value, the moving capability, the skill release capability, and the like, thus indirectly impacting the match state of the game match.

For example, the target weather includes at least one of: the fog weather, the night weather, the snowstorm weather, the sandstorm weather, or the thunderstorm weather.

In some embodiments, the fog weather or the night weather is used to reduce the visibility of the virtual objects and, thus, is not conducive to players to observe the surrounding scene environment and other virtual objects. In practical implementation, for the night weather, the scene brightness of the game scene can be reduced; and for the fog weather, a smoke special effect can be added to the game scene, thus reducing the visual clarity of the virtual objects in the game scene.

It should be noted that each virtual object in the game scene will be impacted by the target weather, including the controlled virtual object.

For the snowstorm weather, it is used to reduce the health value of the virtual object, and certain conditions can also be set. For example, when the energy value of the virtual object is low, the snowstorm weather can continuously reduce the health value of the virtual object. Specifically, a snowstorm special effect can be added to the game scene, and the health value of the virtual object in the game scene is controlled to be continuously reduced. For example, a health value reduction rule is set, and the health value of the virtual object is reduced based on the rule.

For the sandstorm weather, it is used to reduce the moving capability of the virtual objects. After the virtual object enters the sandstorm weather, the moving speed is reduced. Specifically, a sandstorm special effect can be added to the game scene, and the moving speed of the virtual objects can be reduced. For example, when the player issues the same moving control instruction, the default moving speed is multiplied by a parameter less than 1, thus the moving speed of the virtual object is reduced.

For the thunderstorm weather, it is used to reduce shooting capability of the virtual objects. For example, in the thunderstorm weather, the aiming accuracy of the virtual objects is reduced. Upon performing shooting with gun items, the recoil is improved, and the shooting stability is reduced. The special effects of thunder field weather can also be added in the game scene. When the player controls the gun item to shoot, a certain recoil parameter value is added on the basis of the default recoil parameter value of the gun item, and the shooting stability of the gun item is reduced.

In practical implementation, after the first item is released, the target weather can appear in a certain period of time in the future. For example, the target weather appears for one minute, and then returns to normal weather after one minute. In order to ensure the normal process of the game match, it can be set that only one target weather can appear in the game scene at the same time, and when the current target weather takes effect, other weather cannot take effect.

In the implementations of another scene item, the scene item can change the terrain of all or part of the game scene, and impact the object states of the virtual objects through the change of terrain. Specifically, in response to the release operation on the first item, the item effect area is determined based on the item release position of the first item. The specified terrain is generated in the item effect area, where the specified terrain is configured to generate the impact corresponding to the specified terrain on the virtual object in the specified terrain.

The item release position can be the same as or different from the position of the controlled virtual object. In one implementation, the item release position can be selected from the scene map, and the item release range can be preset to a fixed size, or the release range can be scaled from the scene map. Based on the item release position and the item release range, the item effect area is determined, and the specified terrain in the item effect area is generated.

Different terrains usually have different impacts on the virtual objects. As an example, the specified terrain includes at least one of: the swamp terrain, the low-gravity terrain or the skill-disable terrain.

In the game scene, after the first item is released, the area map or area model structure of the item's action area can be changed, thus the terrain effect can be displayed. Then, the virtual object located in the specified terrain is detected, and the related object parameters of the virtual object are changed according to the terrain characteristic of the specified terrain.

Specifically, the swamp terrain is configured to reduce moving capability of the virtual object in the swamp terrain. Specifically, it can reduce the moving speed of virtual objects in the swamp terrain. For example, when the player issues the same moving control instruction, the default moving speed is multiplied by a parameter less than 1, thus the moving speed of the virtual object is reduced.

The above low-gravity terrain is configured to reduce jumping capability of the virtual object in the low-gravity terrain. For example, after the virtual object jumps, it can jump at a high height, but the falling speed is slow. After the player issues the jumping control instruction, the jumping height is increased based on the default jumping height and the falling speed is reduced based on the default falling speed. The implementation may expose the position of the virtual object and increase the probability of being hit by other virtual objects.

The above skill-disable terrain is configured to reduce skill release capability of the virtual object in the skill-disable terrain. For example, in the skill-disable terrain, the virtual object cannot use all or part of the item skills. After the player issues a skill release instruction, the skill release instruction is not activated, or the release function of the skill is reduced. For example, the damage ability of the skill is reduced, or the release range of the skill is reduced.

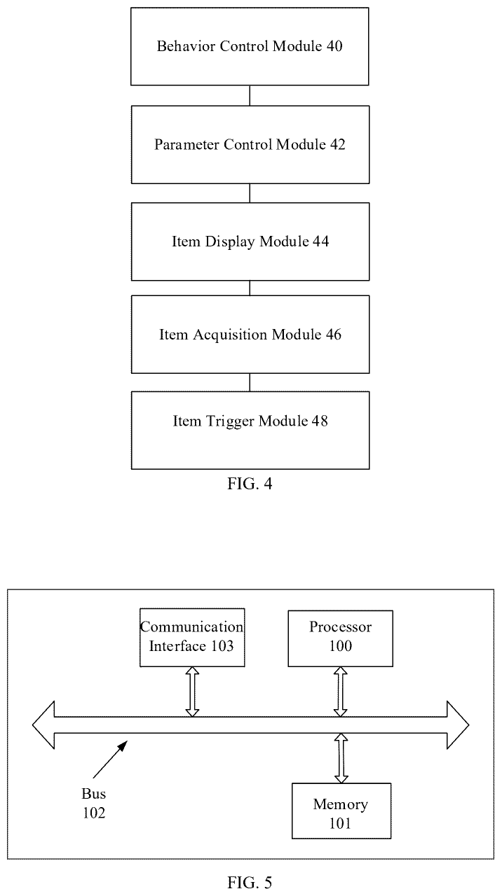

Corresponding to the above method embodiments, the schematic diagram of an interactive controlling apparatus in the game is shown in FIG. 4, where the graphical user interface is provided through the first terminal device; the graphical user interface includes the current game match interface; the current game match interface includes the game scene and the controlled virtual object located in the game scene; and the controlled virtual object is controlled through the terminal device. The apparatus includes:
a behavior control module 40, configured to, in response to the interactive behavior operation, control controlled virtual object to execute the interactive behavior against the specified object; where the specified object includes at least one of the following virtual objects: the object located in game scene and controlled through the preset game program, and the object controlled through the second terminal device;
a parameter control module 42, configured to, in response the interactive behavior and the specified object satisfying the interaction condition, update the attribute parameter of the specified object according to the interactive behavior, and increase the experience parameter of the controlled virtual object according to the preset rule;
a item display module 44, configured to, in response to the experience parameter reaching the preset experience threshold, increase object level of the controlled virtual object in the game match, determine at least part of candidate items from the specified item set, and display the candidate items;
an item acquisition module 46, configured to, in response to the selection operation of the first item from the candidate items, control the controlled virtual object to acquire the first item; and
an item trigger module 48, configured to, in response to the trigger operation of the first item, control to execute the game behavior corresponding to the first item in the game scene.

For the above interactive controlling apparatus in the game, the graphical user interface is provided through the first terminal device; the graphical user interface includes the current game match interface; the current game match interface includes the game scene and the controlled virtual object located in the game scene; the controlled virtual object is controlled through the terminal device; and the method includes the followings. In response to the interactive behavior operation, the controlled virtual object is controlled to execute the interactive behavior against the specified object; where the specified object includes at least one of following virtual objects: the object located in the game scene and controlled through the preset game program, and the object controlled through the second terminal device. In response to the interactive behavior and the specified object satisfying the interaction condition, the attribute parameter of the specified object is updated according to the interactive behavior, and the experience parameter of the controlled virtual object is increased according to the preset rule. In response to the experience parameter reaching the preset experience threshold, the object level of the controlled virtual object in the game match is increased, at least part of candidate items are determined from the specified item set, and the candidate items are displayed. In response to the selection operation on the first item from the candidate items, the controlled virtual object is controlled to acquire the first item. In response to the trigger operation on the first item, the game behavior corresponding to the first item in the game scene are controlled to execute. In the above modes, during the progression of the game character in the game match, the experience parameters are increased through the fight with environmental objects and player objects. The item set is determined based on the object level, and the candidate items are selected from the item set. Players may then choose the item from the candidate items. The implementation enhances the freshness and randomness of character progression operations, reduces the player loss rate, and improves the utilization rate of game service resources.

The above behavior control module is further configured to, in response to the attack operation against the specified object, control the controlled virtual object to execute the attack action against the specified object, or control the controlled virtual object to release the attack item to the specified object.

The above parameter control module is further configured to, in response to the interactive behavior successfully acting on the specified object, control the health parameter of the specified object to reduce based on the impact degree of the interactive behavior on the specified object, and control the experience parameter of the controlled virtual object to increase.

The above apparatus further includes a parameter increasing module configured to, in response to the controlled virtual object entering the game scene, increase the experience parameter of the controlled virtual object based on the scene duration of the controlled virtual object in the game scene.

The above apparatus further includes a parameter setting module configured to set the attribute parameter of the controlled virtual object based on the object level; where the attribute parameter includes multiple parameters from: the attack power parameter, the defense power parameter, the health parameter, and the movement speed; and the higher the object level, the greater the parameter value of the attribute parameter.

The above item display module is further configured to, in response to the experience parameter reaching the preset experience threshold, display the item acquisition control in the graphical user interface; and in response to the first trigger operation on item acquisition control, determine the at least part of candidate items from the specified item set and display the candidate items.

The above item display module is further configured to, in response to the experience parameter reaching the preset experience threshold, display the interaction prompt control in the graphical user interface; where the interaction prompt control is configured to prompt to execute the interaction operation of acquiring the item; and in response to the trigger operation on the interaction prompt control, display the item acquisition control in the graphical user interface.

The first item is configured to, in response to the trigger operation, perform at least one of the following game behaviors: the gain effect for the controlled virtual object in the game scene is controlled to generate; and/or the specified scene object in the game scene is controlled to update, causing the controlled virtual object and the virtual object other than the controlled virtual object to execute the current game match in the updated specified scene object.

The above apparatus further includes a set determining module configured to determine at least one specified item set from multiple candidate item sets based on the object level of the controlled virtual object; where different candidate item sets contain items with different item attributes.

The above candidate item sets include the active item set, the passive item set, and the scene item set. The active item set includes the active item, and the active item is configured to, after the release operation is performed on the active item, release the item function to the item release target object of the active item. The passive item set includes the passive item, and the passive item is configured to, after being acquired by the controlled virtual object, release the item function to the item release target object of the passive item. The scene item set includes the scene item, and the scene item is configured to, after the release operation is performed on the scene item, release the item function to the item release target scene position of the scene item, thereby impacting both the controlled virtual object and the virtual object.

The above set determining module is further configured to, when the object level of the controlled virtual object is the first level, the specified item set includes the active item set; when the object level of the controlled virtual object is the second level, the specified item set includes the passive item set; where in the current game match, the second level is higher than the first level; and the object level of the controlled virtual object increases from the first level to the second level; when the object level of the controlled virtual object is the third level, the specified item set includes the scene item set; where in the current game match, the third level is higher than the second level; and the object level of the controlled virtual object increases from the second level to the third level.

The above item display module is further configured to, randomly determine at least part of candidate items from specified item set, and display the candidate items.

The above item display module is further configured to determine at least part of candidate items from the specified item set, display the candidate items, and maintain the resource quantity of the specified resource of the controlled virtual object unchanged. The above apparatus further includes an update display module configured to, in response to the second trigger operation, update the resource quantity of the specified resource of the controlled virtual object; and re-determine at least part of candidate items from the specified item set, and update display of determined candidate items.

The specified resource of the controlled virtual object is: the virtual currency owned by the game account corresponding to the controlled virtual object outside the current game match, where the virtual currency is used for acquiring the virtual article provided by the game outside the current game match.

The above apparatus further includes a set updating module configured to, when the first item belongs to the scene item set, delete the first item from the scene item set to obtain the updated scene item set; where the updated scene item set is used for providing the scene item to the virtual object other than the controlled virtual object in the current game match.

The above item trigger module is further configured to, in response to the release operation on the first item, update the specified scene state of the game scene, and update the object states of at least part of the virtual objects based on the updated specified scene state.

The above target scene area is preset in the game scene; the range of the target scene area changes according to the default area adjustment rule and based on the match progress of the current game match; the object attribute of the virtual object in the scene area outside the target scene area changes according to the default attribute adjustment rule. The above item trigger module is further configured to, in response to the release operation on the first item, control to modify the range of the target scene area and/or modify the range change time of the target scene area according to the rule adjustment parameter corresponding to the first item, where the rule adjustment parameter is different from the default area adjustment rule.

The range of the target scene area gradually reduces according to the match progress of the current game match; the health value of the virtual object in the scene area outside the target scene area gradually reduces. The above item trigger module is further configured to, in response to the release operation on the first item, update the range of the target scene area based on the position of the controlled virtual object in the game scene.

The range of the target scene area gradually reduces according to the match progress of the current game match; the health value of the virtual object in the scene area outside the target scene area gradually reduces. The above item trigger module is further configured to, in response to the release operation on the first item, when the release time of the first item belongs to the range static stage of the target scene area, advance or postpone the range change time of the target scene area; and when the release time of the first item belongs to the change stage of the range of the target scene area, increase or decrease the change speed of the range of the target scene area.

The above item trigger module is further configured to, in response to the release operation on the first item, control the scene weather of the game scene to change to the target weather. The target weather is configured to generate the impact corresponding to the target weather on the object state of the virtual object in the game scene.

The above target weather includes at least one of: the fog weather, the night weather, the snowstorm weather, the sandstorm weather, or the thunderstorm weather. The fog weather or the night weather is configured to reduce visibility of the virtual object; the snowstorm weather is configured to reduce the health value of the virtual object; the sandstorm weather is configured to reduce moving capability of the virtual object; and the thunderstorm weather is configured to reduce shooting capability of the virtual object.

The above item trigger module is further configured to, in response to the release operation on the first item, determine the item effect area based on the item release position of the first item, generate the specified terrain in the item effect area; where the specified terrain is configured to generate the impact corresponding to the specified terrain on the virtual object in the specified terrain.

The above specified terrain includes at least one of: the swamp terrain, the low-gravity terrain, and the skill-disable terrain. The swamp terrain is configured to reduce moving capability of the virtual object in the swamp terrain; the low-gravity terrain is configured to reduce jumping capability of the virtual object in the low-gravity terrain; and the skill-disable terrain is configured to reduce skill release capability of the virtual object in the skill-disable terrain.

The present embodiments further provide the electronic device, including the processor and the memory storing the machine-executable instruction capable of being executed by the processor, where the processor executes the machine-executable instruction to implement the above method for interactive controlling in the game. The electronic device can be the server or the terminal device.

Referring to FIG. 5, the electronic device includes the processor 100 and the memory 101 storing the machine-executable instruction capable of being executed by the processor 100, where the processor 100 executes the machine-executable instruction to implement the above method for interactive controlling in the game.

Further, the electronic device shown in FIG. 5 also includes a bus 102 and a communication interface 103, and the processor 100, the communication interface 103 and the memory 101 are connected through the bus 102.

The memory 101 may include high-speed Random Access Memory (RAM) or non-volatile memory, such as at least one disk memory. The communication connection between the network element of the system and at least one other network element is implemented through at least one communication interface 103 (which can be wired or wireless), and an internet, a wide area network, a local network, a metropolitan area network, and the like can be used. The bus 102 can be an ISA bus, a PCI bus or an EISA bus. The bus can be divided into an address bus, a data bus, a control bus, and the like. For the convenience of representation, only one double-headed arrow is used in FIG. 5, but it does not mean that only one bus or one type of bus exists.

The processor 100 may be an integrated circuit chip with signal processing capability. In the process of implementation, each step of the above method can be implemented by an integrated logic circuit of hardware or instructions in the form of software in the processor 100. The above processor 100 may be a general-purpose processor, including a Central Processing Unit (CPU), a Network Processor (NP), and the like. It can also be a Digital Signal Processor (DSP), an Application Specific Integrated Circuit (ASIC), a Field-Programmable Gate Array (FPGA) or other programmable logic devices, discrete gate or transistor logic devices, discrete hardware components. The methods, steps and logic block diagrams disclosed in the embodiments of the present disclosure may be implemented or performed. The general processor can be a microprocessor; or the processor can be any conventional processor, and the like. The steps of the method disclosed in the embodiments of the present disclosure may be directly implemented by a hardware decoding processor, or executed through a combination of software modules and hardware within the decoding processor. The software modules can be located in the random-access memory, the flash memory, the read-only memory, the programmable read-only memory or the electrically erasable programmable memory, the registers and other mature storage medium in the art. The storage medium is located in the memory 101. The processor 100 reads the information in the memory 101, and implements the steps of the above method according to the embodiments in combination with its hardware.

The processor of the above electronic device can implement the following operations in the above method for interactive controlling in the game by executing machine-executable instruction.

The graphical user interface is provided through the first terminal device; the graphical user interface includes the current game match interface; the current game match interface includes the game scene and the controlled virtual object located in the game scene; the controlled virtual object is controlled through the terminal device. In response to the interactive behavior operation, the controlled virtual object is controlled to execute the interactive behavior against the specified object; where the specified object includes at least one of following virtual objects: the object located in the game scene and controlled through the preset game program, and the object controlled through the second terminal device. In response to the interactive behavior and the specified object satisfying the interaction condition, the attribute parameter of the specified object is updated according to the interactive behavior, and the experience parameter of the controlled virtual object is increased according to the preset rule. In response to the experience parameter reaching the preset experience threshold, the object level of the controlled virtual object in the game match is increased, at least part of candidate items are determined from the specified item set, and the candidate items are displayed. In response to the selection operation on the first item from the candidate items, the controlled virtual object is controlled to acquire the first item. In response to the trigger operation on the first item, the game behavior corresponding to the first item in the game scene are controlled to execute.

In response to the attack operation against the specified object, the controlled virtual object is controlled to execute the attack action against the specified object, or the controlled virtual object is controlled to release the attack item to the specified object.

In response to the interactive behavior successfully acting on the specified object, the health parameter of the specified object is controlled to reduce based on the impact degree of the interactive behavior on the specified object, and the experience parameter of the controlled virtual object is controlled to increase.

In response to the controlled virtual object entering the game scene, the experience parameter of the controlled virtual object is increased based on the scene duration of the controlled virtual object in the game scene.

The attribute parameter of the controlled virtual object is set based object level; where the attribute parameter includes multiple parameters of: the attack power parameter, the defense power parameter, the health parameter, and the movement speed; and the higher the object level, the greater a parameter value of the attribute parameter.

In response to the experience parameter reaching the preset experience threshold, the item acquisition control is displayed in the graphical user interface; and in response to the first trigger operation on item acquisition control, the at least part of candidate items are determined from the specified item set and the candidate items are displayed.

In response to the experience parameter reaching the preset experience threshold, the interaction prompt control is displayed in the graphical user interface; where the interaction prompt control is configured to prompt to execute the interaction operation of acquiring the item; and in response to the trigger operation on the interaction prompt control, the item acquisition control is displayed in the graphical user interface.

The first item is configured to, in response to the trigger operation, perform at least one of the following game behaviors: the gain effect for the controlled virtual object in the game scene is controlled to generate; and/or the specified scene object in the game scene is controlled to update, causing the controlled virtual object and the virtual object other than the controlled virtual object to execute the current game match in the updated specified scene object.

At least one specified item set is determined from multiple candidate item sets based on the object level of the controlled virtual object; where different candidate item sets contain items with different item attributes.

The candidate item sets include the active item set, the passive item set, and the scene item set. The active item set includes the active item, and the active item is configured to, after the release operation is performed on the active item, release the item function to the item release target object of the active item. The passive item set includes the passive item, and the passive item is configured to, after being acquired by the controlled virtual object, release the item function to the item release target object of the passive item. The scene item set includes the scene item, and the scene item is configured to, after the release operation is performed on the scene item, release the item function to the item release target scene position of the scene item, thereby impacting both the controlled virtual object and the virtual object.

When the object level of the controlled virtual object is the first level, the specified item set includes the active item set; when the object level of the controlled virtual object is the second level, the specified item set includes the passive item set, where in the current game match, the second level is higher than the first level, and the object level of the controlled virtual object increases from the first level to the second level; when the object level of the controlled virtual object is the third level, the specified item set includes the scene item set, where in the current game match, the third level is higher than the second level, and the object level of the controlled virtual object increases from the second level to the third level.

The at least part of candidate items are determined from the specified item set and the candidate items are displayed.

At least part of candidate items are determined from the specified item set, the candidate items are displayed, and the resource quantity of the specified resource of the controlled virtual object is maintained unchanged. In response to the second trigger operation, the resource quantity of the specified resource of the controlled virtual object is updated; and at least part of candidate items are re-determined from the specified item set, and display of determined candidate items is updated.

The specified resource of the controlled virtual object is: the virtual currency owned by the game account corresponding to the controlled virtual object outside the current game match, where the virtual currency is used for acquiring the virtual article provided by the game outside the current game match.

When the first item belongs to the scene item set, the first item is deleted from the scene item set to obtain the updated scene item set; where the updated scene item set is used for providing the scene item to the virtual object other than the controlled virtual object in the current game match.

In response to the release operation on the first item, the specified scene state of the game scene is updated. The object states of at least part of the virtual objects are updated based on the updated specified scene state.

The target scene area is preset in the game scene; the range of the target scene area changes according to the default area adjustment rule and based on the match progress of the current game match; the object attribute of the virtual object in the scene area outside the target scene area changes according to the default attribute adjustment rule. In response to the release operation on the first item, the range of the target scene area is controlled to modify and/or the range change time of the target scene area is controlled to modify according to the rule adjustment parameter corresponding to the first item, where the rule adjustment parameter is different from the default area adjustment rule.

The range of the target scene area gradually reduces according to the match progress of the current game match; the health value of the virtual object in the scene area outside the target scene area gradually reduces. In response to the release operation on the first item, the range of the target scene area is updated based on the position of the controlled virtual object in the game scene.

The range of the target scene area gradually reduces according to the match progress of the current game match; the health value of the virtual object in the scene area outside the target scene area gradually reduces. In response to the release operation on the first item, when the release time of the first item belongs to the range static stage of the target scene area, the range change time of the target scene area is advanced or postponed; when the release time of the first item belongs to the change stage of the range of the target scene area, the change speed of the range of the target scene area is increased or decreased.

In response to the release operation on the first item, the scene weather of the game scene is controlled to change to the target weather. The target weather is configured to generate the impact corresponding to the target weather on the object state of the virtual object in the game scene.

The target weather includes at least one of: the fog weather, the night weather, the snowstorm weather, the sandstorm weather, or the thunderstorm weather. The fog weather or the night weather is configured to reduce visibility of the virtual object; the snowstorm weather is configured to reduce the health value of the virtual object; the sandstorm weather is configured to reduce moving capability of the virtual object; and the thunderstorm weather is configured to reduce shooting capability of the virtual object.

In response to the release operation on the first item, the item effect area is determined based on the item release position of the first item. The specified terrain is generated in the item effect area; where the specified terrain is configured to generate the impact corresponding to the specified terrain on the virtual object in the specified terrain.

The specified terrain includes at least one of: the swamp terrain, the low-gravity terrain, and the skill-disable terrain. The swamp terrain is configured to reduce moving capability of the virtual object in the swamp terrain; the low-gravity terrain is configured to reduce jumping capability of the virtual object in the low-gravity terrain; and the skill-disable terrain is configured to reduce skill release capability of the virtual object in the skill-disable terrain.

In the above implementations, during the progression of the game character in the game match, the experience parameters are increased through the fight with environmental objects and player objects. The item set is determined based on the object level, and the candidate items are selected from the item set. Players may then choose items from the candidate items. The implementation enhances the freshness and randomness of character progression operations, reduces the player loss rate, and improves the utilization rate of game service resources.

The embodiments further provide the machine-readable storage medium storing the machine-executable instruction, where, when the machine-executable instruction is called and executed by the processor, the machine-executable instruction cause the processor to implement the above method for interactive controlling in the game.

The above machine-readable storage medium stores the machine-executable instruction, and the following operations in the above method for interactive controlling in the game can be implemented by executing the machine-executable instruction.

The graphical user interface is provided through the first terminal device; the graphical user interface includes the current game match interface; the current game match interface includes the game scene and the controlled virtual object located in the game scene; the controlled virtual object is controlled through the terminal device. In response to the interactive behavior operation, the controlled virtual object is controlled to execute the interactive behavior against the specified object; where the specified object includes at least one of following virtual objects: the object located in the game scene and controlled through the preset game program, and the object controlled through the second terminal device. In response to the interactive behavior and the specified object satisfying the interaction condition, the attribute parameter of the specified object is updated according to the interactive behavior, and the experience parameter of the controlled virtual object is increased according to the preset rule. In response to the experience parameter reaching the preset experience threshold, the object level of the controlled virtual object in the game match is increased, at least part of candidate items are determined from the specified item set, and the candidate items are displayed. In response to the selection operation on the first item from the candidate items, the controlled virtual object is controlled to acquire the first item. In response to the trigger operation on the first item, the game behavior corresponding to the first item in the game scene are controlled to execute.

In response to the attack operation against the specified object, the controlled virtual object is controlled to execute the attack action against the specified object, or the controlled virtual object is controlled to release the attack item to the specified object.

In response to the interactive behavior successfully acting on the specified object, the health parameter of the specified object is controlled to reduce based on the impact degree of the interactive behavior on the specified object, and the experience parameter of the controlled virtual object is controlled to increase.

In response to the controlled virtual object entering the game scene, the experience parameter of the controlled virtual object is increased based on the scene duration of the controlled virtual object in the game scene.

The attribute parameter of the controlled virtual object is set based object level; where the attribute parameter includes multiple parameters of: the attack power parameter, the defense power parameter, the health parameter, and the movement speed; and the higher the object level, the greater a parameter value of the attribute parameter.

In response to the experience parameter reaching the preset experience threshold, the item acquisition control is displayed in the graphical user interface; and in response to the first trigger operation on item acquisition control, the at least part of candidate items are determined from the specified item set and the candidate items are displayed.

In response to the experience parameter reaching the preset experience threshold, the interaction prompt control is displayed in the graphical user interface; where the interaction prompt control is configured to prompt to execute the interaction operation of acquiring the item; and in response to the trigger operation on the interaction prompt control, the item acquisition control is displayed in the graphical user interface.

The first item is configured to, in response to the trigger operation, perform at least one of the following game behaviors: the gain effect for the controlled virtual object in the game scene is controlled to generate; and/or the specified scene object in the game scene is controlled to update, causing the controlled virtual object and the virtual object other than the controlled virtual object to execute the current game match in the updated specified scene object.

At least one specified item set is determined from multiple candidate item sets based on the object level of the controlled virtual object; where different candidate item sets contain items with different item attributes.

The candidate item sets include the active item set, the passive item set, and the scene item set. The active item set includes the active item, and the active item is configured to, after the release operation is performed on the active item, release the item function to the item release target object of the active item. The passive item set includes the passive item, and the passive item is configured to, after being acquired by the controlled virtual object, release the item function to the item release target object of the passive item. The scene item set includes the scene item, and the scene item is configured to, after the release operation is performed on the scene item, release the item function to the item release target scene position of the scene item, thereby impacting both the controlled virtual object and the virtual object.

When the object level of the controlled virtual object is the first level, the specified item set includes the active item set; when the object level of the controlled virtual object is the second level, the specified item set includes the passive item set, where in the current game match, the second level is higher than the first level, and the object level of the controlled virtual object increases from the first level to the second level; when the object level of the controlled virtual object is the third level, the specified item set includes the scene item set, where in the current game match, the third level is higher than the second level, and the object level of the controlled virtual object increases from the second level to the third level.

The at least part of candidate items are determined from the specified item set and the candidate items are displayed.

At least part of candidate items are determined from the specified item set, the candidate items are displayed, and the resource quantity of the specified resource of the controlled virtual object is maintained unchanged. In response to the second trigger operation, the resource quantity of the specified resource of the controlled virtual object is updated; and at least part of candidate items are re-determined from the specified item set, and display of determined candidate items is updated.

The specified resource of the controlled virtual object is: the virtual currency owned by the game account corresponding to the controlled virtual object outside the current game match, where the virtual currency is used for acquiring the virtual article provided by the game outside the current game match.

When the first item belongs to the scene item set, the first item is deleted from the scene item set to obtain the updated scene item set; where the updated scene item set is used for providing the scene item to the virtual object other than the controlled virtual object in the current game match.

In response to the release operation on the first item, the specified scene state of the game scene is updated. The object states of at least part of the virtual objects are updated based on the updated specified scene state.

The target scene area is preset in the game scene; the range of the target scene area changes according to the default area adjustment rule and based on the match progress of the current game match; the object attribute of the virtual object in the scene area outside the target scene area changes according to the default attribute adjustment rule. In response to the release operation on the first item, the range of the target scene area is controlled to modify and/or the range change time of the target scene area is controlled to modify according to the rule adjustment parameter corresponding to the first item, where the rule adjustment parameter is different from the default area adjustment rule.

The range of the target scene area gradually reduces according to the match progress of the current game match; the health value of the virtual object in the scene area outside the target scene area gradually reduces. In response to the release operation on the first item, the range of the target scene area is updated based on the position of the controlled virtual object in the game scene.

The range of the target scene area gradually reduces according to the match progress of the current game match; the health value of the virtual object in the scene area outside the target scene area gradually reduces. In response to the release operation on the first item, when the release time of the first item belongs to the range static stage of the target scene area, the range change time of the target scene area is advanced or postponed; when the release time of the first item belongs to the change stage of the range of the target scene area, the change speed of the range of the target scene area is increased or decreased.

In response to the release operation on the first item, the scene weather of the game scene is controlled to change to the target weather. The target weather is configured to generate the impact corresponding to the target weather on the object state of the virtual object in the game scene.

The target weather includes at least one of: the fog weather, the night weather, the snowstorm weather, the sandstorm weather, or the thunderstorm weather. The fog weather or the night weather is configured to reduce visibility of the virtual object; the snowstorm weather is configured to reduce the health value of the virtual object; the sandstorm weather is configured to reduce moving capability of the virtual object; and the thunderstorm weather is configured to reduce shooting capability of the virtual object.

In response to the release operation on the first item, the item effect area is determined based on the item release position of the first item. The specified terrain is generated in the item effect area; where the specified terrain is configured to generate the impact corresponding to the specified terrain on the virtual object in the specified terrain.

The specified terrain includes at least one of: the swamp terrain, the low-gravity terrain, and the skill-disable terrain. The swamp terrain is configured to reduce moving capability of the virtual object in the swamp terrain; the low-gravity terrain is configured to reduce jumping capability of the virtual object in the low-gravity terrain; and the skill-disable terrain is configured to reduce skill release capability of the virtual object in the skill-disable terrain.

In the above implementations, during the progression of the game character in the game match, the experience parameters are increased through the fight with environmental objects and player objects. The item set is determined based on the object level, and the candidate items are selected from the item set. Players may then choose items from the candidate items. The implementation enhances the freshness and randomness of character progression operations, reduces the player loss rate, and improves the utilization rate of game service resources.

The computer program product of the interactive controlling method, apparatus and electronic device in the game provided by the embodiments of the present disclosure includes a computer-readable storage medium in which program codes are stored, and the instructions included in the program codes can be used to execute the method according to the above method embodiments, and the specific implementation can be found in the method embodiments, which will not be elaborated here.

It can be clearly understood by those skilled in the art that for the convenience and conciseness of description, with respect to the specific working process of the system and apparatus described above, the corresponding process in the above method embodiments can be referred to, which will not be elaborated here.

In addition, in the description of the embodiments of the present disclosure, unless otherwise specified and limited, the terms “install”, “connect” and “join” should be broadly understood. For example, they can be fixed connection, detachable connection or integrated connection; they can be mechanical connection or electrical connection; and they can be direct connection, can also be indirect connection through an intermediate medium, and can be connection inside two elements. For those skilled in the art, the specific meanings of the above terms in the present disclosure can be understood in specific situations.

The functions can be stored in one computer-readable storage medium if they are realized in the form of software functional units and sold or used as independent products. Based on the understanding, in essence, the technical solution of the present disclosure, the part that contributes to related technologies and the part of the technical solution can be embodied in form of software product. The computer software product is stored in one storage medium and includes several instructions to make one computer device (which can be a personal computer, a server, or a network device, etc.) execute all or part of the steps of the method according to various embodiments of the present disclosure. The above storage medium includes: U disk, mobile hard disk, Read-Only Memory (ROM), Random Access Memory (RAM), magnetic disk or optical disk and other medium that can store program codes.

In the description of the present disclosure, it should be noted that the orientation or positional relationship indicated by the terms “center”, “upper”, “lower”, “left”, “right”, “vertical”, “horizontal”, “inside” and “outside” are the orientation or positional relationship based on the attached drawings. The terms are only for the convenience of describing the present disclosure and simplifying the description, rather than indicating or implying that the referred device or element must have the specific orientation, or must be constructed and operated in the specific orientation, and therefore should not be considered as a limitation of the present disclosure. In addition, the terms “first”, “second” and “third” are only used for descriptive purposes and cannot be understood as indicating or implying relative importance.

Finally, it should be explained that the above embodiments are only specific implementations of the present disclosure, which are used to illustrate the technical solution of the present disclosure, but not to limit it. Although the present disclosure has been described in detail with reference to the above embodiments, it should be understood that any person skilled in the art, within the technical scope disclosed in the present disclosure, may still modify the technical solutions described in the above embodiments, easily think of variations of the technical solutions described in the above embodiments, or make equivalent substitutions to some of the technical features. Such modifications, variations, or substitutions shall not cause the essential aspects of the corresponding technical solutions to depart from the spirit and scope of the technical solutions of the embodiments of the present disclosure, and shall be encompassed within the protection scope of the present disclosure. Therefore, the protection scope of the present disclosure should be based on the protection scope of the claims.

1. A method for interactive controlling in a game, comprising:
in response to an interactive behavior operation, controlling a controlled virtual object to execute an interactive behavior against a specified object; wherein a graphical user interface is provided through a first terminal device, the graphical user interface comprises a current game match interface, the current game match interface comprises a game scene and the controlled virtual object located in the game scene, the controlled virtual object is controlled through the first terminal device, and the specified object comprises at least one of: an object located in the game scene and controlled through a preset game program, or an object controlled through a second terminal device;
in response to the interactive behavior and the specified object satisfying an interaction condition, updating an attribute parameter of the specified object according to the interactive behavior, and increasing an experience parameter of the controlled virtual object according to a preset rule;
in response to the experience parameter reaching a preset experience threshold, increasing an object level of the controlled virtual object in a game match, determining at least part of candidate items from a specified item set, and displaying the candidate items;
in response to a selection operation on a first item from the candidate items, controlling the controlled virtual object to acquire the first item; and
in response to a trigger operation on the first item, displaying a game behavior corresponding to the first item in the game scene.

2. The method according to claim 1, wherein in response to the interactive behavior operation, controlling the controlled virtual object to execute the interactive behavior against the specified object comprises:
in response to an attack operation against the specified object, controlling the controlled virtual object to execute an attack action against the specified object, or controlling the controlled virtual object to release an attack item to the specified object.

3. The method according to claim 1, wherein in response to the interactive behavior and the specified object satisfying the interaction condition, updating the attribute parameter of the specified object according to the interactive behavior comprises:
in response to the interactive behavior successfully acting on the specified object, reducing a health parameter of the specified object based on an impact degree of the interactive behavior on the specified object.

4. The method according to claim 1, further comprising:
in response to the controlled virtual object entering the game scene, increasing the experience parameter of the controlled virtual object based on a scene duration of the controlled virtual object in the game scene.

5. The method according to claim 1, comprising:
setting the attribute parameter of the controlled virtual object based on the increased object level; wherein the attribute parameter comprises multiple parameters selected from: an attack power parameter, a defense power parameter, a health parameter, and a movement speed; and the higher the object level, the greater a parameter value of the attribute parameter.

6. The method according to claim 1, wherein determining at least part of candidate items from the specified item set comprises:
displaying an item acquisition control in the graphical user interface; and
in response to a first trigger operation on the item acquisition control, determining the at least part of candidate items from the specified item set.

7. The method according to claim 6, wherein displaying the item acquisition control in the graphical user interface comprises:
displaying an interaction prompt control in the graphical user interface; and
in response to a trigger operation on the interaction prompt control, displaying the item acquisition control in the graphical user interface.

8. The method according to claim 1, wherein the first item is configured to, in response to the trigger operation, execute at least one of:
generating a gain effect for the controlled virtual object in the game scene; or
updating a specified scene object in the game scene, causing the controlled virtual object and a virtual object other than the controlled virtual object to execute the current game match in an updated specified scene object.

9. The method according to claim 1, further comprising:
determining the specified item set from multiple candidate item sets based on the object level of the controlled virtual object; wherein different candidate item sets contain items with different item attributes.

10. The method according to claim 9, wherein the candidate item sets comprise an active item set, a passive item set, and a scene item set;
wherein the active item set comprises an active item, and the active item is configured to, in response to a release operation being performed on the active item, release an item function to an item release target object of the active item;
the passive item set comprises a passive item, and the passive item is configured to, in response to being acquired by the controlled virtual object, release an item function to an item release target object of the passive item;
the scene item set comprises a scene item, and the scene item is configured to, in response to a release operation being performed on the scene item, release an item function to an item release target scene position of the scene item, thereby impacting both the controlled virtual object and the specified object.

11. The method according to claim 9, wherein determining the specified item set from multiple candidate item sets based on the object level of the controlled virtual object comprises at least one of:
determining, in response to the object level being a first level, the specified item set as comprising an active item set;
determining, in response to the object level being a second level, the specified item set as comprising a passive item set; wherein in the current game match, the second level is higher than the first level;
determining, in response to the object level being a third level, the specified item set as comprising a scene item set; wherein in the current game match, the third level is higher than the second level.

12. (canceled)

13. The method according to claim 1, further comprising:
in response to the candidate items being displayed, maintaining a resource quantity of a specified resource corresponding to the controlled virtual object unchanged;
in response to a second trigger operation, updating the resource quantity of the specified resource; and
re-determining at least part of candidate items from the specified item set, and updating displaying of determined candidate items.

14. (canceled)

15. The method according to claim 1, further comprising:
in response to the acquired first item belonging to a scene item set, deleting the first item from the scene item set to obtain an updated scene item set; wherein the updated scene item set is used for providing a scene item to a virtual object other than the controlled virtual object in the current game match.

16. The method according to claim 1, wherein in response to the trigger operation of the first item, displaying the game behavior corresponding to the first item in the game scene comprises:
in response to a release operation on the first item, updating a specified scene state of the game scene; and
updating an object state of a virtual object based on an updated specified scene state.

17. The method according to claim 16, wherein a target scene area is preset in the game scene; a range of the target scene area changes according to a default area adjustment rule and based on a match progress of the current game match; an object attribute of a virtual object in a scene area outside the target scene area changes according to a default attribute adjustment rule; and
updating the specified scene state of the game scene comprises: modifying the range of the target scene area or modifying a range change time of the target scene area according to a rule adjustment parameter corresponding to the first item, wherein the rule adjustment parameter is different from the default area adjustment rule.

18. The method according to claim 17, wherein the range of the target scene area gradually reduces based on the match progress of the current game match; a health value of the virtual object in the scene area outside the target scene area gradually reduces; and
modifying the range of the target scene area according to the rule adjustment parameter corresponding to the first item comprises: updating the range of the target scene area based on a position of the controlled virtual object in the game scene; or
modifying the range change time of the target scene area according to the rule adjustment parameter corresponding to the first item comprises: in response to a release time of the first item belonging to a range static stage of the target scene area, advancing or postponing the range change time of the target scene area; in response to the release time of the first item belonging to a change stage of the range of the target scene area, increasing or decreasing a change speed of the range of the target scene area.

19. (canceled)

20. The method according to claim 16, wherein updating the specified scene state of the game scene comprises:
changing a scene weather of the game scene to a target weather; wherein the target weather is configured to generate an impact corresponding to the target weather on an object state of a virtual object in the game scene;
wherein the target weather comprises at least one of:
a fog weather or a night weather, configured to reduce visibility of the virtual object;
a snowstorm weather, configured to reduce a health value of the virtual object;
a sandstorm weather, configured to reduce moving capability of the virtual object; and
a thunderstorm weather, configured to reduce shooting capability of the virtual object.

21. (canceled)

22. The method according to claim 16, wherein updating the specified scene state of the game scene comprises:
determining an item effect area based on an item release position of the first item; and
generating a specified terrain in the item effect area; wherein the specified terrain is configured to generate an impact corresponding to the specified terrain on a virtual object in the specified terrain,
wherein the specified terrain comprises at least one of:
a swamp terrain, configured to reduce moving capability of the virtual object in the swamp terrain;
a low-gravity terrain, configured to reduce jumping capability of the virtual object in the low-gravity terrain; or
a skill-disable terrain, configured to reduce skill release capability of the virtual object in the skill-disable terrain.

23-24. (canceled)

25. An electronic device, comprising a processor and a memory storing a machine-executable instruction capable of being executed by the processor, wherein the processor executes the machine-executable instruction to implement operations comprising:
in response to an interactive behavior operation, controlling a controlled virtual object to execute an interactive behavior against a specified object; wherein a graphical user interface is provided through a first terminal device, the graphical user interface comprises a current game match interface, the current game match interface comprises a game scene and the controlled virtual object located in the game scene, the controlled virtual object is controlled through the first terminal device, and the specified object comprises at least one of: an object located in the game scene and controlled through a preset game program, or an object controlled through a second terminal device;
in response to the interactive behavior and the specified object satisfying an interaction condition, updating an attribute parameter of the specified object according to the interactive behavior, and increasing an experience parameter of the controlled virtual object according to a preset rule;
in response to the experience parameter reaching a preset experience threshold, increasing an object level of the controlled virtual object in a game match, determining at least part of candidate items from a specified item set, and displaying the candidate items;
in response to a selection operation on a first item from the candidate items, controlling the controlled virtual object to acquire the first item; and
in response to a trigger operation on the first item, displaying a game behavior corresponding to the first item in the game scene.

26. A non-transitory machine-readable storage medium storing a machine-executable instruction, wherein, when the machine-executable instruction is called and executed by a processor, the machine-executable instruction cause the processor to implement operations comprising:
in response to an interactive behavior operation, controlling a controlled virtual object to execute an interactive behavior against a specified object; wherein a graphical user interface is provided through a first terminal device, the graphical user interface comprises a current game match interface, the current game match interface comprises a game scene and the controlled virtual object located in the game scene, the controlled virtual object is controlled through the first terminal device, and the specified object comprises at least one of: an object located in the game scene and controlled through a preset game program, or an object controlled through a second terminal device;
in response to the interactive behavior and the specified object satisfying an interaction condition, updating an attribute parameter of the specified object according to the interactive behavior, and increasing an experience parameter of the controlled virtual object according to a preset rule;
in response to the experience parameter reaching a preset experience threshold, increasing an object level of the controlled virtual object in a game match, determining at least part of candidate items from a specified item set, and displaying the candidate items;
in response to a selection operation on a first item from the candidate items, controlling the controlled virtual object to acquire the first item; and
in response to a trigger operation on the first item, displaying a game behavior corresponding to the first item in the game scene.
